(19) United States
(12) Patent Application Publication
(10) Pub. No.: US 2006/0087914 A1
(43) Pub. Date: Apr. 27, 2006

(54) Automated mixing machine for paint bases and colorants

(76) Inventor: Edmund Albert Eckart JR., Marina Del Rey, CA (US)

Correspondence Address: E Albert Eckart Jr., 4037 Via Marina Apt 305H, Marina Del Rey, CA, 90292-6265, US

(21) Appl. No.: 10/972,217

(22) Filed: Oct. 25, 2004

(51) Int. Cl. B01F 11/00

(52) U.S. Cl. 366/209

(57) ABSTRACT

An apparatus that enables an individual to make custom paint colors with out handling the paint cans during the colorant dispensing and mixing operation. This is achieved by a system that mechanically removes the lids of gallons and quarts, then dispenses the correct colorants into the selected paint base, reseals the lids, and then mixes together the paint and colorants. All these steps take place in a single chamber. Selected gallons or quarts are inserted onto a duel level platform. Each level fits the base diameter of the two sizes. The cans are gripped by a groove engaging their bottom seams. The cans are lowered and raised by the platform for lid removal and lid resealing,—using vacuum heads which have chamber holes for lid attachment and then finally mixing. After colorants are dispensed into the cans from above, the platform lowers for the Mixing process. The four steps—lid removal, dispensing, lid resealing and then mixing—all take place in a single chamber protected by a locking door—secured until the mixing is complete. This chamber is open at the top to accept colorant injection. All steps are made possible by a rotating platform base that raises and lowers and returns the finished canister for removal.

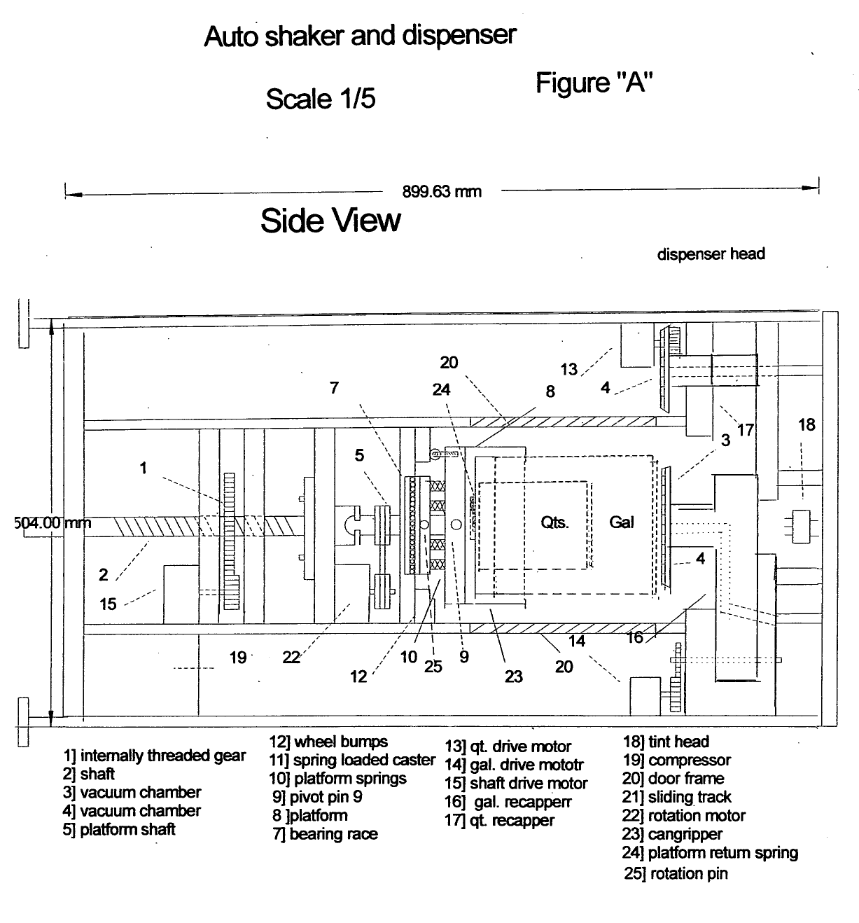

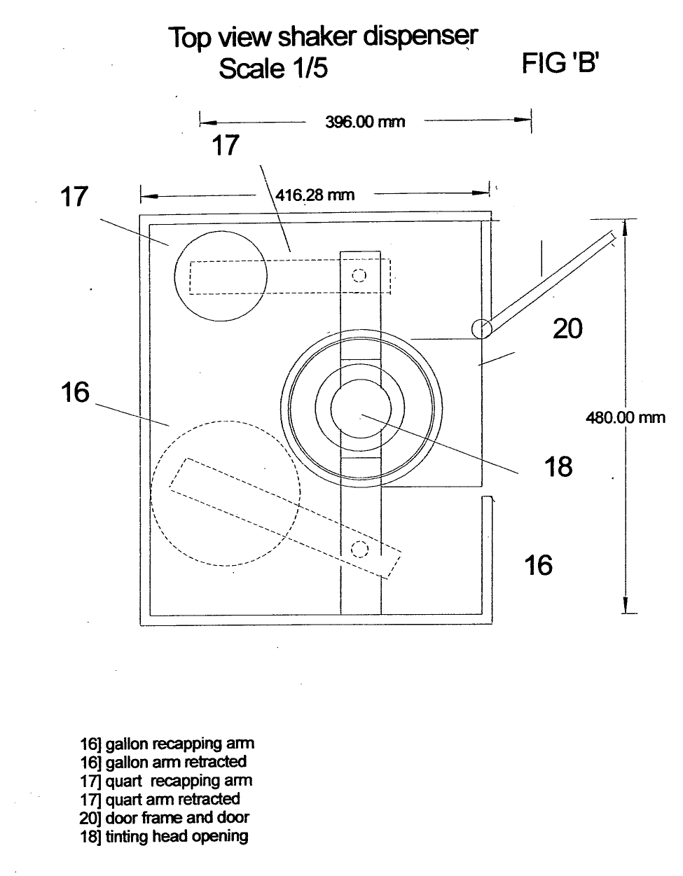

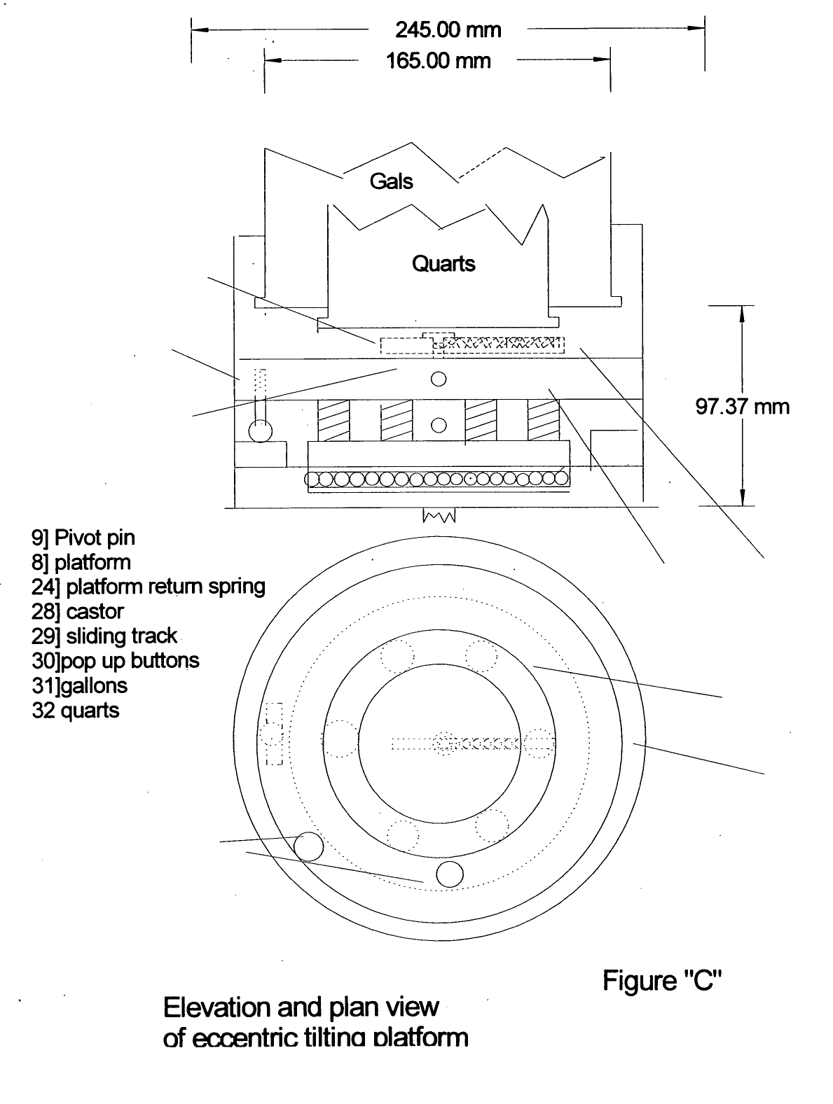

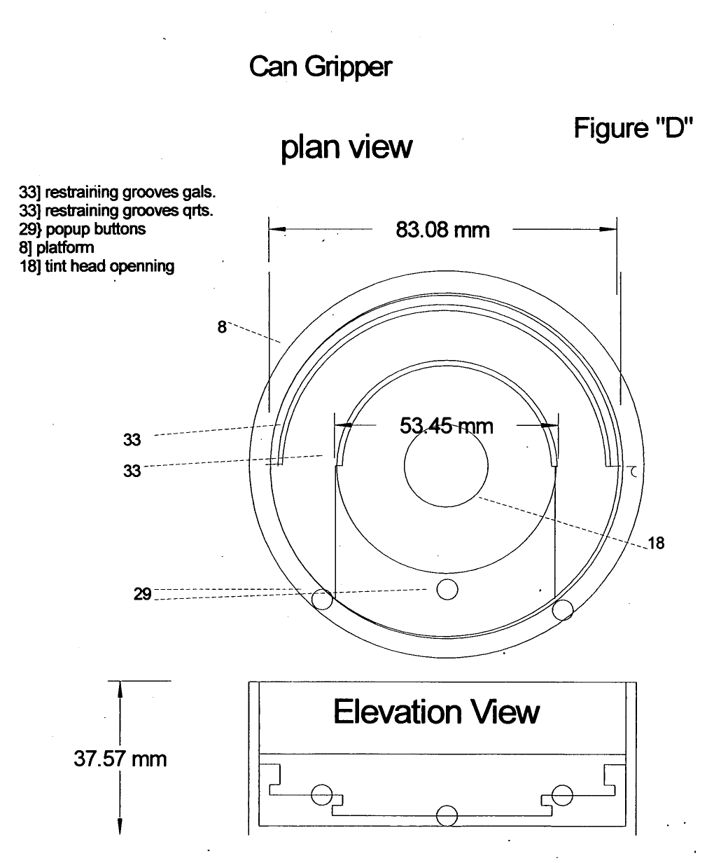

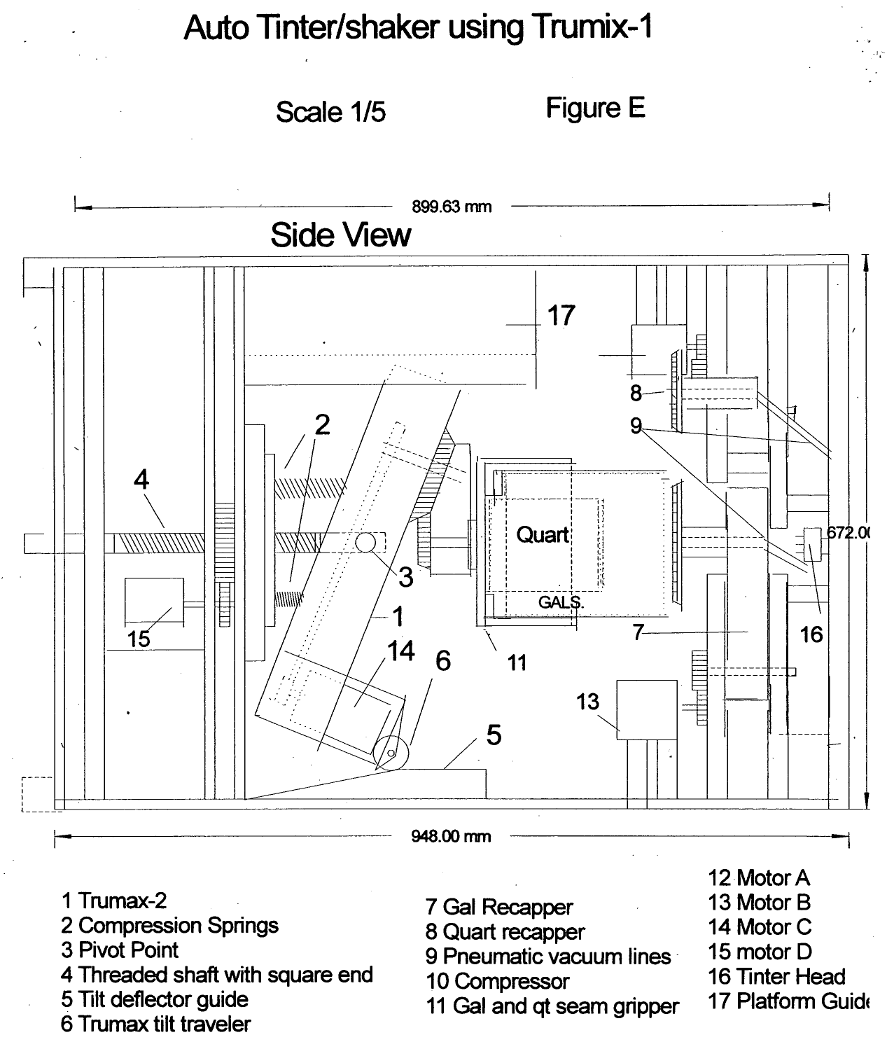

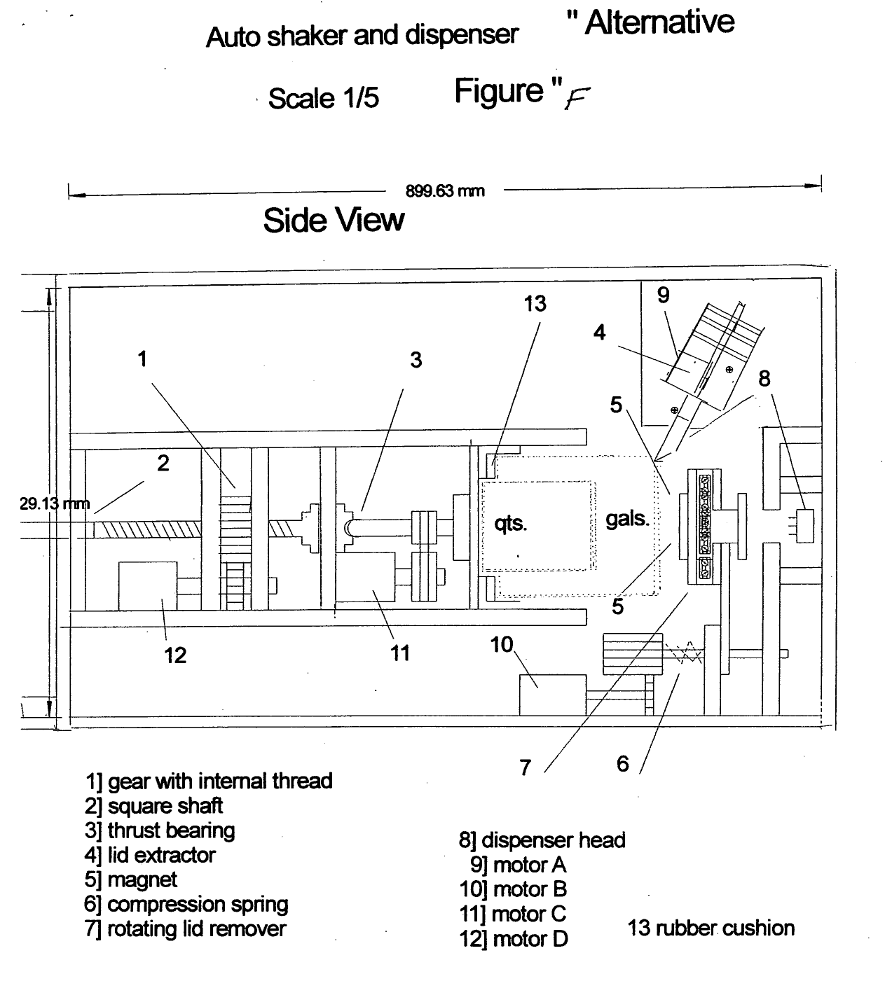

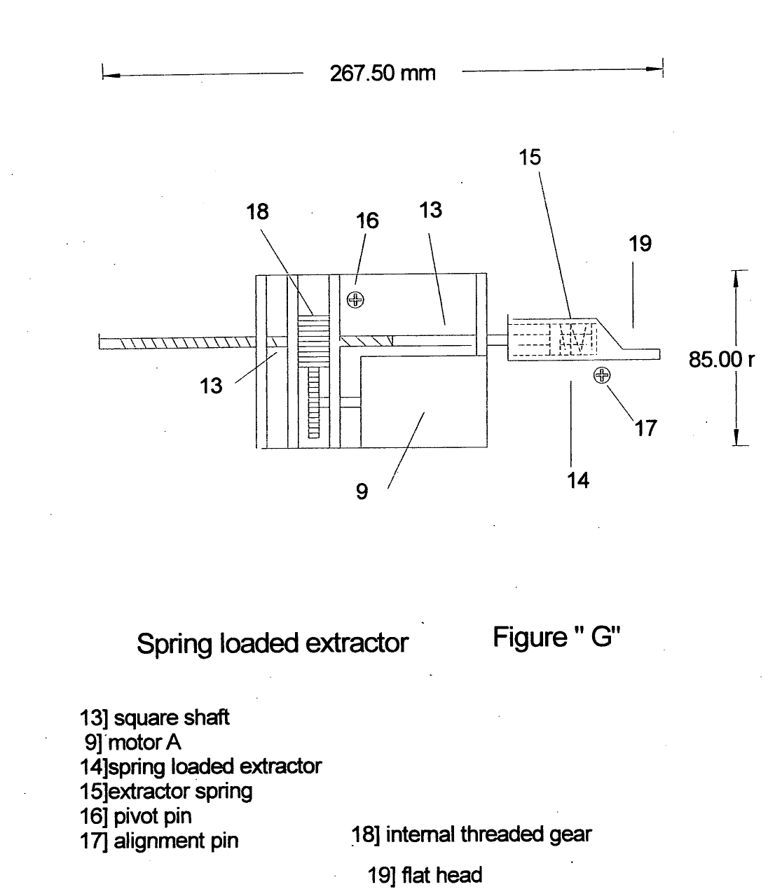

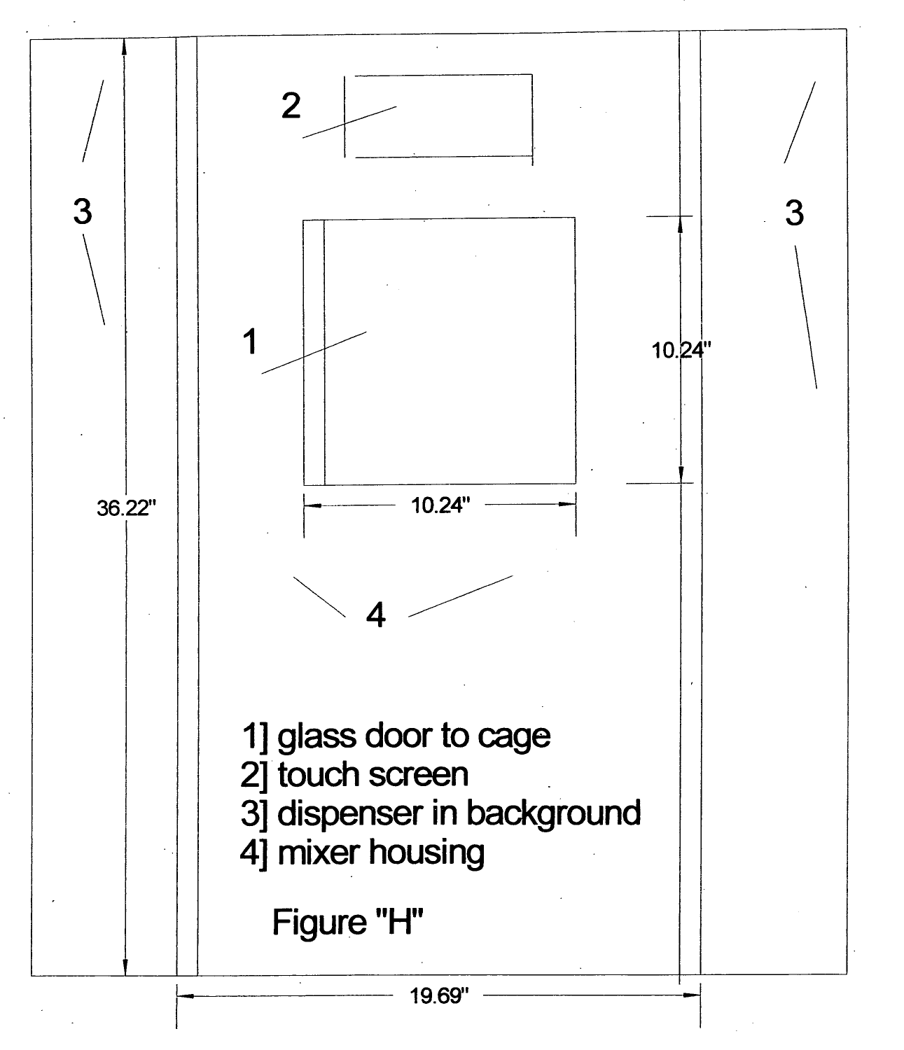

### DISCRIPTION OF RELATED ART

Currently the process of producing custom colors involves a customer selecting a color chip from a display of thousands of colors, handing this selection to a clerk and informing him of her selection of finish and the size of the container she wishes to select, I.e. a “gallon of a chosen color number in a flat finish”. The clerk checks his computer, or more often a printed manual, and reads from the monitor or the manual the number and selection which designates a specific base to be tinted. He selects the base, pries open the lid, and places it onto the dispenser shelf and clicks on the monitor “dispense button” or handles the whole dispensing operation on a manual basis. When dispensing is complete, he removes the gallon, pounds back on the lid, and then places the canister in a separate shaker for mixing. When mixing is complete he removes the container for delivery to the customer. Many times paint spilling is encountered during this process. No paint stores or departments will ever allow a customer to carry out these procedures on his own.

All of these functions are done in my invention easily by the customer in an enclosed housing, out of harms way. He need only select a color from the display. Then press in the color number or swipe the bar code and press in the selected size and finish on a simple screen. He is then directed to select the correct base which he places in the apparatus and closes the door. Minutes later the door opens and the customer retrieves his paint purchase.

### SUMMARY OF THE INVENTION

The present invention is directed to an apparatus which automatically removes paint container lids, both quarts and gallons, displaces them out of the way to accept dispensed colorant from a separate dispenser, then repositions the lids to their proper position, seals them on the container, and moves the containers to a lower level to be mixed by a novel mixer or an optional industry standard mixer. These steps are achieved through the use of rotating pneumatic attachment heads for lid removal and repositioning and a vertical platform for resealing and further positioning. All of these steps take place in a single vertical moving mechanism with a novel designed dual level platform to accommodate and grip both quarts and gallons.

The design specifically illustrates how the canisters are to be restrained from upward movement during the lid extraction phase by engaging their welded seams, which are slightly larger in circumference then the vertical walls of the pant canisters. This dual level platform involves the quart being inserted at a lower level then the gallon so that when it is driven upward and downward for the various steps of the process it has a clear passage to contact it's vacuum head.

The gallon container, when selected, then slides onto a higher shelf. The invention contemplates using a small compressor driven pneumatic vacuum system to remove, displace and replace the lids of quarts and gallons.

An alternate method uses an apparatus which exerts a prying force on a paint lid as the can is simultaneously rotated until the lid is released—similar to a manual extraction. The lids, attached by magnets or a vacuum are rotated out of the way at to receive dispensed colorants. This extractor is extendable to reach farther for quarts then gallons and is spring loaded to prevent jamming. This is not the preferred system over the vacuum approach as it may require constant calibration to engage at an angle the narrow slot between the lid and the can.

Mixing

The present invention contemplates a proprietary mixing system which includes a spring mounted platform which becomes eccentric upon rotation and revolves at a slight angle due to the slightly greater depression of the outer platform springs. The platform also experiences a simultaneous upward and downward motion as it follows on castors an uneven pathway with rises and falls. The mixing system also uses a pawl in the platform wherein the upper platform slides into an eccentric position as soon centrifugal rotation commences. Upon completion the platform is centered for it's upward movement by a retrieval spring upon the cessation of rotation.

### BRIEF DESCRIPTION OF THE DRAWINGS

FIG. A] is an elevation view of the dispenser apparatus shown on it's side with a plurality of different mechanisms to effect the required results.

FIG. B] is a plan view of the apparatus with the re-cappers in a retracted position.

FIG. C} is an elevation and plan view blow up of a description of the eccentric Rotating platform which follows an uneven pathway to effect a shaking motion. It is spring cushioned and slides 10 mm off center by centrifugal force to effect an eccentric rotation motion, thereby mixing the paint base and colorant.

FIG. D] is a plan and elevation view of the tilting platform showing the restraining grooves which engage the welded paint can seems.

FIG. E] is an elevation view of an alternative mixing approach using a standard industry dual axel mixer. It demonstrates the use of a tilting platform which adjusts the level of the tops of the paint canisters into a horizontal position for lid removal, tinting and lid resealing before the mixing process.

FIG. F] is an alternative approach to lid removal and resealing. Shown is an elevation view in a horizontal version of a method of prying lid removal, tinting and lid resealing followed by straight rotational mixing or utilizing one of the two mixing systems described in plan “C” or “E”

FIG. G] is a blow up of the pivoting lid removal mechanism system described in fig “E” showing an extendable and retractable flat head remover which extends to accommodate both quarts and gallons. It is spring loaded to prevent jamming during the upward and down ward extraction cycle triggered by the motion of the platform.

FIG. H} illustrates the housing unit where dimensions are expressed in inches.

### DESCRIPTION OF THE PREFERRED EMBODIMENTS

FIG. “A” the elevation of the apparatus is shown in a horizontal position, and according to the present invention consists of a forward and reversing motor 15 which drives an internally threaded gear and spindle 1 and 2 raising platform 8 upward and downward. Motor 22 rotates platform 8. Motor 22 is controlled to stop in a position to afford easy can insertion and retraction of the paint containers through the apparatus door 6. Rotating platform shaft 5 turns tilting platform 8 which bears on bearing race 7 Platform 8 is supported by compression springs 10. Platform 8 is attached to shaft 5 by the use of a pivot pin 9. Platform 8 utilizes a wheel and spring loaded castor 11 to follow a pathway over wheel bumps 12 during mixing.

Platform 8 is slotted as a pawl shown in a blow up in figure D. The top of Platform 8 slides 10 mm to the side during rotational mixing by centrifugal force controlled by a square head fitting as part of shaft 5 which slides in this slot as a pawl. Motor 22 moves the paint cans secured by restraining device 23 upward to contact chambers 3 or 4 depending on whether quarts or gallons are inserted. Vacuum chamber 3 or 4 are energized to attach the paint lids of quarts or gallons as the case may be through vacuum lines 4. Gallon re-capper 16 or quart re-capper 17 are rotated with paint lids attached out of the way to accommodate colorant dispensing through tinting head 18. Upon completion of tinting rotating arms 16 or 17 move the paint lids back in line with the paint cans and motor 15 drives shaft 5 upwards to re-seal the paint lids. Motor 15 lowers the platform 10 mm and motor 22 commences paint mixing rotation. Upon completion motor 22 raises platform 8 for paint removal through door 6 which automatically unlocks.

FIG. “B” is a plan view of the top of the device shoeing the gallon and quart re-cappers in their retracted positions.—16 and 17 ready for colorant injection.

FIG. “C” is a blowup of the shaking sector of the apparatus. 8 is the tilting platform which rotates on wheel castor 11 following pathway bumps 27. The platform pivots on pivot pin 9 and is supported by coil springs 10. A retraction spring 33 returns the platform to center upon completion of rotation. Pop up buttons 29 restrict the paint can lateral movements during rotation.

FIG. “D” is a blow up of a can restrictor device showing the restraining grooves for both gallons and quarts 33 showing the popup buttons 29

FIG. “E” is an alternate mixing device using an industry standard dual axis paint mixer. My invention involves a method of tilting the standard mixer 34 to a horizontal posture by using a traveler 36 and a tilt deflector guide 35 This is further accomplished by the use of a pivot pin 37 and compression springs 38. Other mechanisms are the same as in FIG. “A”.

FIG. “F” is an alternate lid removal, resealing and mixing system which does not use pneumatics for lid removal and replacement.

This inventive approach incorporates a pivoting mechanism 4 which uses a flat head blade 15 to engage the groove between the lid and lip of paint cans for purposes of lid removal. Removal is effected by an upward and downward motion of platform 13 which also simultaneously rotates 90 degrees with the flat head blade 19 engaged until lid removal. At this juncture the canister is raised to make contact with the over head revolving magnetized lid displacement arm 16 Motor 12 raises and lowers platform 13 and motor 11 rotates the platform for purposes of lid removal and mixing. Motor 10 rotates the lid displacement function to accomplish the tinting phase.

FIG. “G” is a blow up of the pivoting extraction mechanism 38. A shaft which expands to accommodate quarts 45. This motion is provided by reversing motor 47 driving internal threaded gear 46. A pivot pin 49 permits the device to rotate 15 degrees to effect removal. A stop pin 50 provides alignment for can lip engagement. The flat head pry 51 is spring loaded to prevent jamming during the upward movement of platform 40 in figure “E”.

FIG. “H” is the apparatus housing.

What is claimed:

1] In an enclosed machine, means for mounting various mechanisms that allow, paint can lid removal, colorant dispensing, lid resealing, and mixing all in the same vertical chamber for both quarts and gallons with safety devices for consumer protection. This concept eliminates all horizontal movements of paint canisters minimizing the machines footprint and allowing different industry colorant dispenser heads to inject colorants through the open top

2] The apparatus achieves claim [1] by the use of a dual level platform to receive both gallons at a higher level and quarts at a lower level. The base welded seams of these standard round containers are gripped by 180 degree exact fitting grooves for both sizes when they are slid into place. Pop up buttons, or other arresting systems, or contact magnets secure the canisters in place during rotational centrifugal mixing

3] The use of a pneumatic vacuum lid attachment to lift and remove the canister lids during the downward movement of the retaining platform and continued attachment of the lids during rotational lid displacement to accommodate colorant dispensing and then counter rotation of the lids for resealing.

4] The use of two separate rotating vacuum heads for quarts and gallons to displace and return canister lids to facilitate dispensing colorants and then resealing the lids. These motor driven heads are especially braced to with stand the extra forces of lid removal and resealing and are designed to exactly fit the inside diameter of lids. a single platform which raises and lowers for both gallons and quarts to enable lid removal, colorant dispensing, lid resealing, and then mixing. The vertical moving platform actuates lid removal, lid resealing, and proper platform positioning for easy canister insertion and removal of gallons and quarts.

6] The use of a clear glass door that auto-locks when a gallon or quart are placed in the apparatus to safe guard against any human manual contact with the canisters during the dispensing and mixing process. Sensors are positioned to detect any improper or incomplete installation of paint canisters in their restraining grooves prohibiting the clear glass safety door from locking and preventing the machine from commencing operations.

7] The use of pop up buttons or other restraining devices and or magnets to prevent the canisters from flying loose during high-speed rotational mixing.

8] The use of a series of sensors which will shut down the apparatus at any time during the sequential steps, if any thing is out of synchronization or calibration.

9] The design of the basic housing unit to include a simple screen which guides the consumer how to proceed—by requesting from them the selected color number, the selected size container, and the desired finish. It then informs them to select the correct tinting base for the color, size and finish selected. A bar code used by some paint companies will be read by a barcode reader installed instead of pressing in the color nr.

10] The use of a custom designed mixer which embraces both eccentric and angular rotation, as well as simultaneous vertical agitation.

11] The use of a special design which uses a spring cushioned platform during mixing rotation which has a pawl permitting paint cans to shift off center by centrifugal force, assuming a slight angular position due to the depression of the outer springs. It is then retrieved to center and an upright position by a spring retractor upon termination of rotation
Alternative Machine to Achieve the Above Results

12] The use of an alternate standard industry dual axis mixer for mixing with a specially designed mechanism to tilt the above apparatus by using a spring cushioned platform which moves from a 15 degree angle [mixing phase] during the mixing process to a horizontal position [retrieving phase] by contacting an inclined obstruction during upward movement.

13] An alternate design of a canister lid retractor which pries lids open by using a flat blade to open the lids of quarts or gallons as the cans are simultaneously rotated by the platform. This extractor is designed to automatically extend to engage quart lids and is spring loaded to prevent jamming. The cans are moved into position by a rotating platform which rises and descends to effect lid removal and lid resealing.

14] The special design of a tray to hold some square gallon containers now sold on the market. The bottom rim of this tray is circular and fits the grooves in only the gallon platform. The top of this new “easy to pour” container is removed by two fingers easily bolted on the gallon vacuum head. When the platform is rotated clockwise or counterclockwise the screw top is either removed or reinstalled by engaging the two stationary fingers on the vacuum chamber head

15] A modular construction housing with an open top to accept any of the electronic automated dispensers now on the market which can be bolted on.
